(19) United States
(12) Patent Application Publication
(10) Pub. No.: US 2024/0226957 A1
(43) Pub. Date: Jul. 11, 2024

(54) MASTIC DISPENSING DEVICE

(71) Applicant: ALBION ENGINEERING COMPANY, Moorestown, NJ (US)

(72) Inventors: JOSEPH B. HANNI, CHERRY HILL, NJ (US); BRIAN J. MacKENZIE, Philadelphia, PA (US)

(73) Assignee: ALBION ENGINEERING COMPANY, Moorestown, NJ (US)

(21) Appl. No.: 18/405,297

(22) Filed: Jan. 5, 2024

Related U.S. Application Data
(60) Provisional application No. 63/437,501, filed on Jan. 6, 2023.

(51) Int. Cl. B05C 17/01; B05C 17/005

(52) U.S. Cl. CPC B05C 17/0123; B05C 17/0052

(57) ABSTRACT

A mastic dispensing device, also referred to as a caulking gun, includes a hanger rotatably mounted to such caulking gun. The rotatably mounted hanger may be useful in setting aside the caulking gun during operation, such as when the user wishes to have both hands free, or is otherwise performing related operations on a swing stage, ladder, scaffolding, and other work fixtures in the work environment. The hanger includes structural features to enable efficient manufacture and use of the hanger in the work environment.

### FIELD

This disclosure relates to hand-held tools used in construction and other building, repair, and renovation projects, in general, and to mastic dispensing devices in particular.

### BACKGROUND

Mastic dispensing devices, also referred to herein as caulking guns, find use in a large variety of environments, jobs, and operations, and may assume a variety of configurations. Such uses and operations often involve situations where the operator needs to set aside the caulking gun, such as when two hands are required for a related task. Oftentimes, it is not easy for the operator to simply set the caulking gun down, as there are no appropriate surfaces in proximity, nor other ability to become “hands-free” to perform related tasks, such as when the operator is on a swing stage, scaffold, ladder, or other work location without suitable surfaces or locations to put the dispensing device down.

Prior art attempts at addressing the foregoing issues have various drawbacks and disadvantages.

### SUMMARY

This disclosure relates to a rotatable, caulking gun hanger which has been configured with various transversely oriented components so as to be cost effectively manufactured, readily mounted to a variety of caulking guns, and operable in dynamic environments, so as to permit the operator to hang the caulking gun on elements of a swing stage, ladder, scaffolding, and other work fixtures in the work environment.

### BRIEF DESCRIPTION OF THE DRAWINGS

FIG. 1 is an isometric view of a caulking gun according to the present disclosure.

FIG. 2 is an exploded perspective view of one suitable implementation of a hanger for the caulking gun of FIG. 1.

FIG. 3 is an enlarged, isometric view of the caulking gun of FIGS. 1-2, showing the hanger in the deployed position.

FIG. 4 is an enlarged, isometric view of the caulking gun of FIGS. 1-3, showing the hanger in the stowed position.

FIG. 5 is a front, elevational view of the caulking gun of FIGS. 1-4, showing the hanger in the stowed position.

FIG. 6 is a front, elevational view of the caulking gun of FIGS. 1-5, showing the hanger in the deployed position.

### DETAILED DESCRIPTION

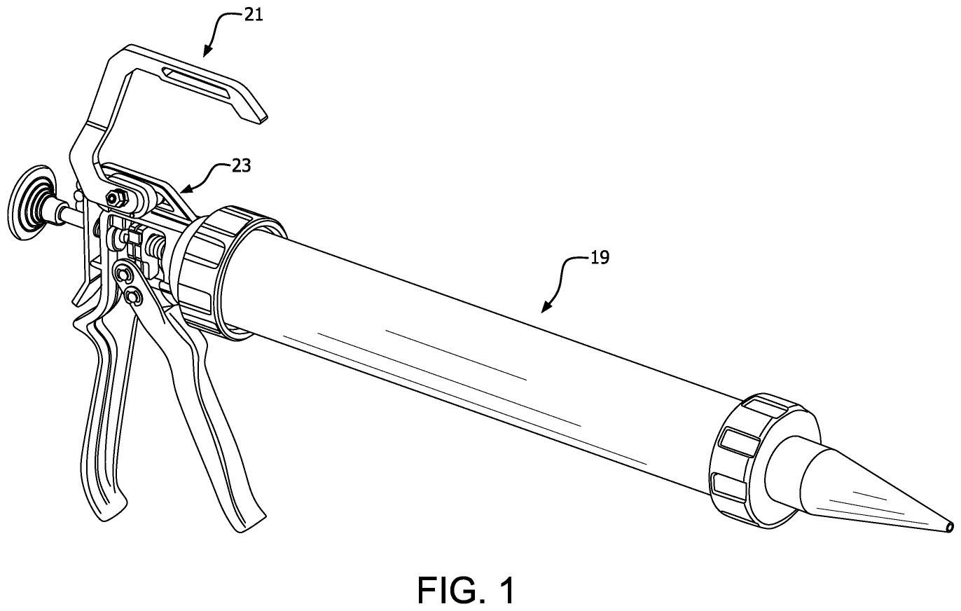

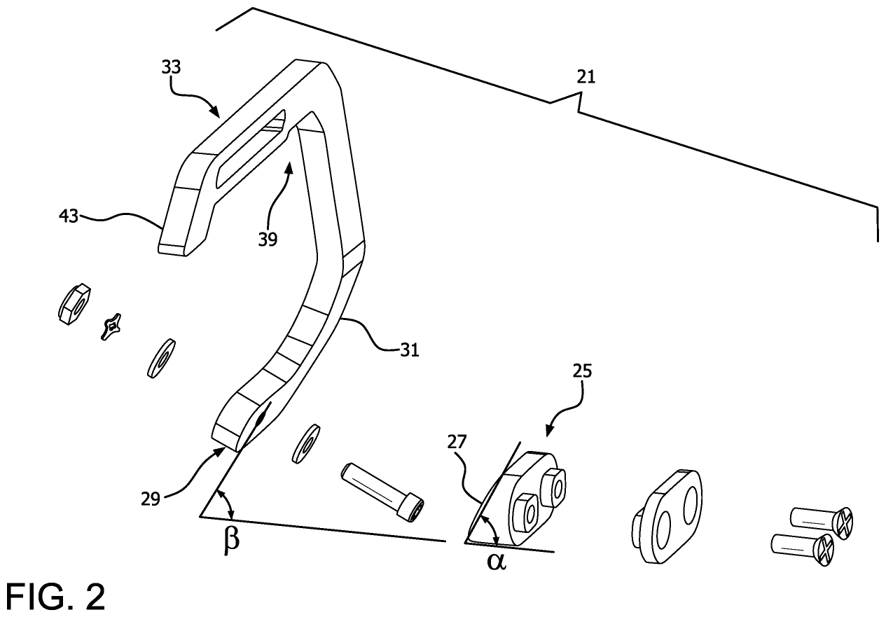

Referring to FIGS. 1-6, caulking gun hanger 21 is rotatably mounted to a mounting plate or spine 23 at the proximal end of a caulking gun 19. Mounting of hanger 21 includes an interposed connector 25 having an angled surface 27 which imparts an angle α to shoulder portion 29 of hanger 21.

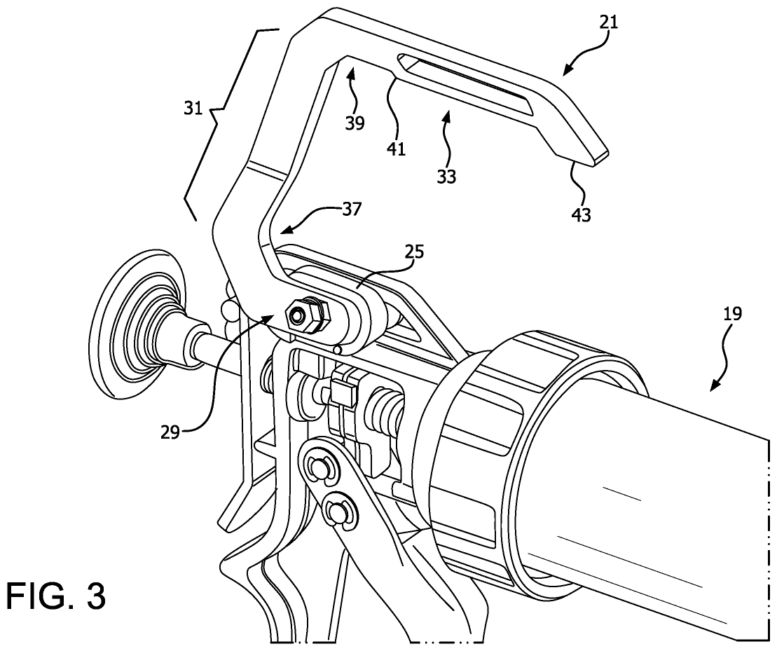

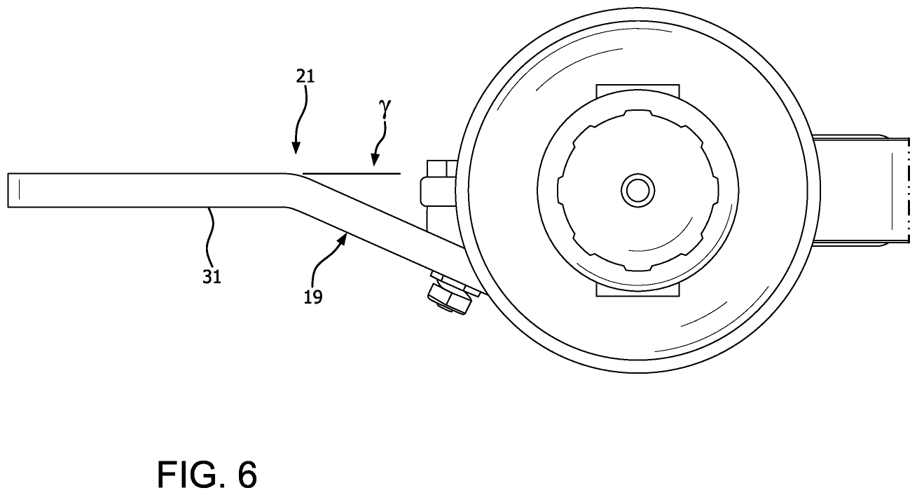

Connected to shoulder 29 is upper arm 31 of hanger 21. Upper arm 31 has a reverse angle I which is substantially equivalent to the value of angle α, which combination of angles allows the upper arm 31 and lower arm 33 extending therefrom to be aligned longitudinally with the center line of the barrel of caulking gun 19 when deployed as shown in FIGS. 3 and 6. The angles α and I may range between 5° and 15° .

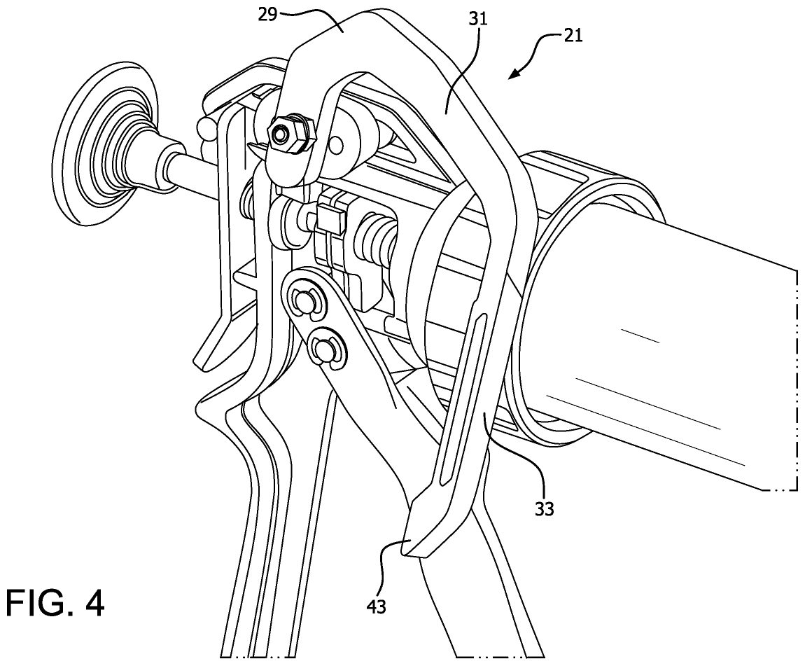

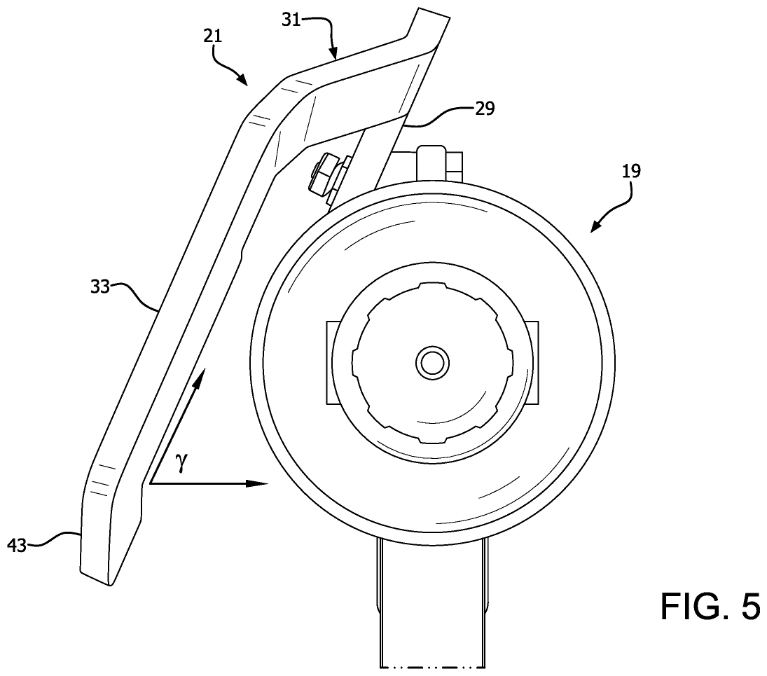

Upper arm 31 extends sufficiently, compared to the radius of the barrel of the caulking gun so that, when hanger 21 is rotated to its stowed position shown in FIGS. 4 and 5, elbow 35 between upper and lower arms 31, 33 clears the housing of tool gun 19.

Shoulder 29 is joined to upper arm 31 at an angle of between 30 and 50 degrees so as to form a recess 37 sized to receive a member of the swing stage or similar members therein.

The inner surface of elbow 35, in turn, forms a crook 39 which is located a transverse distance from recess 37. Crook 39 thus provides an additional recess to retain one or more surfaces of the external member which external member may be in contact with upper arm 31 when seeking to hang dispensing device 19. Crook 39 of elbow 35 has a raised, inwardly extending bevel to assist in maintaining portions of the swing stage received in crook 39.

Lower arm 33 extends longitudinally when deployed, but transversely and at an angle corresponding to the angle of the upper arm, when stowed (FIG. 5). Angle' maycorrespond to the angle of angled surface 27 of connector 25, and thus may range from 10° to 20°. Lower arm 33 extends a sufficient distance to form an inner receiving surface to engage parts of a swing stage as well, if the environment so requires. Lower arm 33 terminates in a finger 43 as an inwardly extending portion to assist in engagement between swing stage components and lower arm 33.

What is claimed is:

1. A caulking gun comprising:
a barrel from which caulk is selectively dispensable, the barrel having a longitudinal axis;
the barrel having a proximal end from which the user may dispense mastic or caulking from the barrel by suitable manipulation of a mechanism located at such proximal end;
the barrel having a distal end from which the mastic exits upon suitable application, the distal end located at the opposite end of the longitudinal axis of the barrel;
wherein a hanger is rotatably mounted to a mounting plate at the proximal end of the caulking gun;
wherein the hanger is suitably configured to be axially aligned with the longitudinal axis of the barrel when in a deployed position;
wherein the hanger may be rotated to a stowed position in which the hanger clears the barrel of the caulking gun;
wherein the hanger includes a plurality of portions configured to be at angles which are transverse to the longitudinal axis.
